(19) United States
(12) Patent Application Publication
(10) Pub. No.: US 2026/0307161 A1
(43) Pub. Date: Oct. 8, 2026

(54) GEAR CHAMFERING METHOD, CHAMFERING TOOL, AND CHAMFERING TOOL MANUFACTURING METHOD

(71) Applicant: OSG CORPORATION, Toyokawa-City, Aichi (JP)

(72) Inventor: Kohshiroh Miwa, Toyokawa-City, Aichi (JP)

(73) Assignee: OSG CORPORATION, Toyokawa-City, Aichi (JP)

(21) Appl. No.: 19/484,482

(22) PCT Filed: May 26, 2023
(86) PCT No.: PCT/JP2023/019745

§ 371 Date: Nov. 14, 2025

(51) Int. Cl. B23F 19/10

(52) U.S. Cl. CPC B23F 19/10

(57) ABSTRACT

A gear chamfering method makes it possible to chamfer a border portion in an axial direction of a tooth flank of each tooth of a gear in a short time. The gear chamfering method includes a chamfering step of chamfering border portions and of a plurality of teeth of a gear by a chamfering tool having a machining edge. In a case where an arbitrary integer is represented by K, the number of the teeth is represented by Zw, and the number of the machining edges is represented by Zt, the chamfering step includes performing K·Zt/Zw rotations of the gear about a rotation axis per rotation of the chamfering tool about a tool axis in a machining orientation in which the tool axis is set non-parallel to the rotation axis.

### TECHNICAL FIELD

The present invention relates to a gear chamfering method, a chamfering tool for chamfering a gear, and a method for manufacturing the chamfering tool.

### BACKGROUND ART

A method is known in which, while a gear is being rotated, a chamfering tool is synchronously rotated about a tool axis parallel to a rotation axis of the gear to chamfer the top lands of teeth of the gear (Patent Document 1). The chamfering tool has a plurality of tool teeth around the tool axis, and the top lands of the tool teeth are brought into contact with the top lands of the gear to chamfer the top lands of the gear.

### PRIOR ART DOCUMENT

### Patent Document

Patent Document 1: Japanese Patent Application Laid-Open (kokai) No. H4-146022

### SUMMARY OF THE INVENTION

### Problem to be Solved by the Invention

However, the chamfering tool disclosed in Patent Document 1 is for chamfering the top lands of a gear and has difficulty in chamfering border portions in an axial direction of tooth flanks of each tooth of the gear. Although a method in which such border portions are chamfered one by one with the end cutting edge of an end mill is known, this method has a problem in that the machining time becomes long.

The present invention has been made to solve the above problems, and an object of the present invention is to provide a gear chamfering method, a chamfering tool, and a chamfering tool manufacturing method that make it possible to chamfer a border portion in an axial direction of a tooth flank of each tooth of a gear in a short time.

### Means for Solving the Problem

In order to achieve the object, a gear chamfering method of the present invention includes a chamfering step of chamfering, by a chamfering tool configured to be rotated about a tool axis, a gear having a plurality of teeth formed around a rotation axis. Each of the plurality of teeth has a tooth flank as a surface oriented in a circumferential direction of the gear and a border portion, in an axial direction of the rotation axis, of the tooth flank. The chamfering tool has at least one machining edge formed around the tool axis into a shape corresponding to a shape of the border portion. An arbitrary integer is represented by K, the number of the teeth is represented by Zw, and the number of the machining edges is represented by Zt. The chamfering step includes performing K·Zt/Zw rotations of the gear about the rotation axis per rotation of the chamfering tool about the tool axis in a machining orientation in which the tool axis is set non-parallel to the rotation axis, and sequentially bringing the machining edge into contact with a plurality of the border portions to chamfer the border portions.

### Advantageous Effects of the Invention

The gear chamfering method according to a first aspect includes a chamfering step of chamfering a border portion, in an axial direction of a rotation axis, of a tooth flank of each of a plurality of teeth of a gear by a chamfering tool having at least one machining edge formed around a tool axis. The chamfering in the chamfering step is performed in a machining orientation in which the tool axis is set non-parallel to the rotation axis. Consequently, the border portion of the gear can be chamfered while the chamfering tool and the gear are being synchronously rotated.

When an arbitrary integer is represented by K, the number of the teeth is represented by Zw, and the number of the machining edges is represented by Zt, the above synchronous rotation involves K·Zt/Zw rotations of the gear about the rotation axis per rotation of the chamfering tool about the tool axis. Through this synchronous rotation, the machining edge having a shape corresponding to a shape of the border portion is sequentially brought into contact with a plurality of the border portions to chamfer the border portions. Therefore, the border portions of the gear can be chamfered in a short time.

A gear chamfering method according to a second aspect exhibits the following advantageous effect in addition to the advantageous effects exhibited by the gear chamfering method according to the first aspect. The number Zt of the machining edges is two or more. The chamfering step includes bringing different ones of the machining edges into contact with respective top land and bottom land sides of one of the border portions to chamfer the top land and bottom land sides. Thus, the shape of the machining edge to be brought into contact with the top land side of the border portion and the shape of the machining edge to be brought into contact with the bottom land side of the border portion may be designed independently of each other, or the machining orientations in which the respective machining edges are brought into contact or the like may be set to differ. By doing so, the size and the angle of the chamfer to be provided to the border portion can be adjusted (e.g., set to be even) between the top land side and the bottom land side.

A gear chamfering method according to a third aspect exhibits the following advantageous effect in addition to the advantageous effects exhibited by the gear chamfering method according to the first aspect. The machining orientation corresponds to a state where the tool axis located on a first imaginary plane including the rotation axis is parallelly shifted from the first imaginary plane in a direction perpendicular to the first imaginary plane. In this case, one or more of the border portions of the plurality of teeth become nearly parallel to the tool axis. The chamfering step includes bringing the machining edge into contact with each of the border portions having become nearly parallel to the tool axis to chamfer the border portion. Consequently, the entirety of this border portion can be chamfered by the machining edge in a short time. As a result, the top land side and the bottom land side of the border portion are equally chamfered by the machining edge, whereby the size and the angle of the chamfer to be provided to the border portion can be set to be even over the entirety of the border portion.

A gear chamfering method according to a fourth aspect exhibits the following advantageous effect in addition to the advantageous effects exhibited by the gear chamfering method according to the first aspect. The machining orientation corresponds to a state where the tool axis is tilted from a second imaginary plane perpendicular to the rotation axis. Consequently, in the chamfering step, rotation of the tool about the tool axis causes the machining edge to tilt accordingly in the circumferential direction of the gear as seen in the axial direction of the rotation axis. This tilt may cause the machining edge and the border portion of any of the teeth to become nearly parallel to each other. When both the machining edge and the border portion become nearly parallel to each other, the machining edge is brought into contact with the border portion to chamfer the border portion. Consequently, the entirety of this border portion can be chamfered by the machining edge in a short time. As a result, the top land side and the bottom land side of the border portion are equally chamfered by the machining edge, whereby the size and the angle of the chamfer to be provided to the border portion can be set to be even over the entirety of the border portion.

A gear chamfering method according to a fifth aspect exhibits the following advantageous effect in addition to the advantageous effects exhibited by the gear chamfering method according to the first aspect. The chamfering tool has a rake surface extending from the machining edge to the tool axis side and facing forward in a rotation direction of the chamfering tool. The rake surface and the machining edge are located on a third imaginary plane including the tool axis, whereby the phase of the machining edge to be rotated about the tool axis can be easily identified from the orientation of the rake surface. Therefore, an initial phase of the machining edge at start of rotation of the machining edge about the tool axis in the chamfering step is determined on the basis of the rake surface, whereby the initial phase can be easily determined.

A gear chamfering tool according to a sixth aspect is used for the gear chamfering method according to the fifth aspect. The machining edge is a portion having a radius smaller than a maximum radius of the chamfering tool and is formed on a front end side in an axial direction of the chamfering tool. The rake surface is extended to a side opposite to the front end side of the chamfering tool beyond a position at which the machining edge is formed. Consequently, the rake surface as a basis for determining the initial phase of the machining edge can be widened. Therefore, the orientation or the like of the rake surface can be easily acquired by a sensor or the like, whereby the initial phase can be more easily determined.

A gear chamfering tool according to a seventh aspect is used for the gear chamfering method according to any one of the first to the fourth aspects. The chamfering tool includes a cutting part formed around the tool axis. The cutting part has: a forward rake surface facing forward in a rotation direction of the chamfering tool; a backward rake surface facing backward in the rotation direction of the chamfering tool; and a connection surface connecting radially outer borders of the forward rake surface and the backward rake surface to each other. An intersection line between the connection surface and the forward rake surface and an intersection line between the connection surface and the backward rake surface form a pair of the machining edges configured to chamfer respective ones of the border portions of the gear.

This makes it possible to, during one rotation of the chamfering tool, chamfer one of the border portions adjacent to each other in the circumferential direction by the machining edge on the forward rake surface side and chamfer the other one of the adjacent border portions by the machining edge on the backward rake surface side, for example. In this case, as compared to a case where both of the adjacent border portions are chamfered by the same machining edge, the machining edges can be formed into shapes suitable for the respective border portions, whereby the size and the angle of the chamfer to be provided to each of the border portions can be easily adjusted.

A chamfering tool manufacturing method according to a eighth aspect is a method for manufacturing the chamfering tool to be used for the gear chamfering method according to any one of the first to the fifth aspects. The chamfering tool has: the at least one machining edge formed around the tool axis; and a rake surface extending from the machining edge to the tool axis side and facing forward in a rotation direction of the chamfering tool.

A gear setting step includes setting a shape of the gear including the number Zw of the teeth and a shape of a chamfer portion to be formed by chamfering each of the border portions of the gear. A rotation plane setting step includes setting a shape of an imaginary rotation plane to be rotated about the tool axis, the imaginary rotation plane being oriented in the rotation direction of the chamfering tool. A condition setting step includes setting an initial phase of the rotation plane set in the rotation plane setting step, the machining orientation in the chamfering step, the arbitrary integer K, and the number Zt of the machining edges.

A subsequent acquisition step includes acquiring an intersection line between the rotation plane and the chamfer portion in each of phases obtained when the K·Zt/Zw rotations of the gear about the rotation axis are performed during one rotation of the rotation plane about the tool axis from the initial phase in the machining orientation based on the settings in the condition setting step and the gear setting step. A formation step includes setting, as the machining edge, a line in contact with a plurality of the intersection lines acquired in the acquisition step and setting, as the rake surface, the rotation plane closer to the tool axis than the machining edge to form the chamfering tool. Therefore, the shape of a chamfer portion to be actually formed through the gear chamfering method according to the first aspect by using this chamfering tool can be made similar to the shape of the chamfer portion set in the gear setting step.

### BRIEF DESCRIPTION OF THE DRAWINGS

FIG. 1 is a perspective view of a gear and a chamfering tool, showing a gear chamfering method in a first embodiment.

FIG. 2A is a front view of the chamfering tool, and

FIG. 2B is a bottom view of the chamfering tool as seen in the direction indicated by the arrow IIb in FIG. 2A.

FIG. 3A is a partially enlarged front view of the gear as seen in the direction indicated by the arrow IIIa in FIG. 1, and FIG. 3B is a partially enlarged plan view of the gear as seen in the direction indicated by the arrow IIIb in FIG. 3A.

FIG. 4 is a schematic diagram showing a part of a chamfering tool manufacturing method.

FIG. 5A is a front view of a chamfering tool to be used for a gear chamfering method in a second embodiment, and FIG. 5B is a bottom view of the chamfering tool as seen in the direction indicated by the arrow Vb in FIG. 5A.

FIG. 6 is a schematic diagram showing a gear chamfering method in a third embodiment.

FIG. 7 is a schematic diagram showing a gear chamfering method in a fourth embodiment.

FIG. 8A is a front view of a chamfering tool to be used for a gear chamfering method in a fifth embodiment, FIG. 8B is a side view of the chamfering tool as seen in the direction indicated by the arrow VIIIb in FIG. 8A, and FIG. 8C is a bottom view of the chamfering tool as seen in the direction indicated by the arrow VIIIc in FIG. 8A.

### MODES FOR CARRYING OUT THE INVENTION

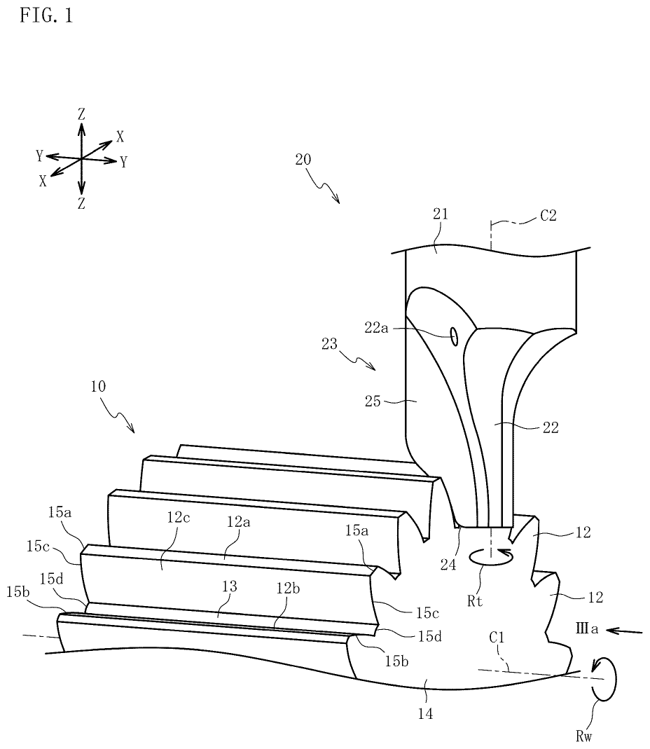

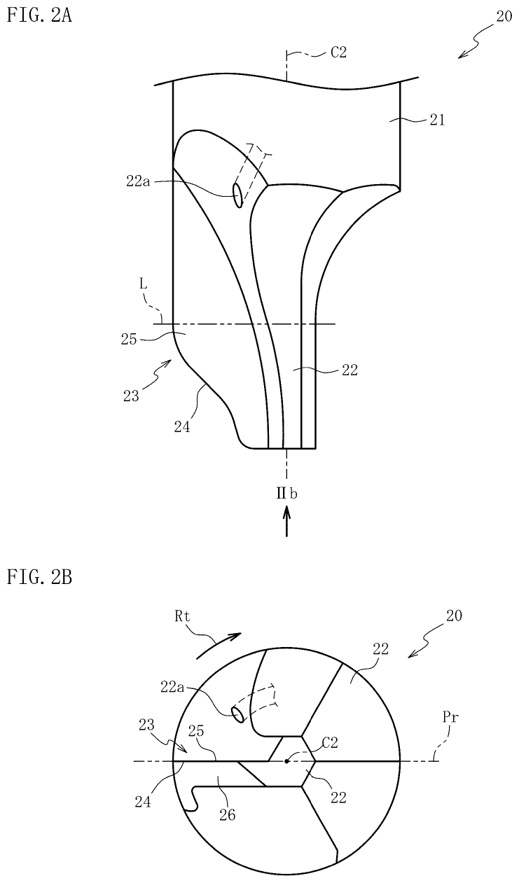

Hereinafter, preferred embodiments will be described with reference to the accompanying drawings. FIG. 1 is a perspective view of a gear 10 and a chamfering tool 20 (hereinafter, referred to as “tool 20”), showing a method for chamfering the gear 10 in a first embodiment. FIG. 2A is a front view of the tool 20. FIG. 2B is a bottom view of the tool 20 as seen in the direction indicated by the arrow IIb in FIG. 2A. FIG. 1 does not show a lower half of the gear 10. FIG. 1 and FIG. 2A do not show a rear end side (upper side) of the tool 20.

As shown in FIG. 1, the gear 10 is an external gear including: a columnar part having a center at a rotation axis C1; and a plurality of (in the present embodiment, 18) teeth 12 protruding outward in a radial direction from an outer circumferential surface of the columnar part. The plurality of teeth 12 are provided at regular intervals around the rotation axis C1 and have mutually identical shapes. The plurality of teeth 12 extend parallel to the rotation axis C1.

The outer circumferential surface of the columnar part of the gear 10 has surfaces between the plurality of teeth 12, the surfaces being bottom land surfaces 13. Each of the teeth 12 has: a top surface in the radial direction, the top surface being a top land surface 12a; and a pair of surfaces connecting the top land surface 12a and the corresponding bottom land surfaces 13 to each other and oriented in a circumferential direction, the pair of surfaces being tooth flanks 12b and 12c. In a case where the right side in FIG. 1 out of sides in an axial direction (arrow-Y direction) of the rotation axis C1 is defined as the front side of the gear 10, the tooth flank 12b is oriented clockwise and the tooth flank 12c is oriented anticlockwise as seen from the front side.

An intersection line between the top land surface 12a and each of end surfaces 14, in the axial direction of the rotation axis C1, of the gear 10 is a border portion 15a. An intersection line between the end surface 14 and the tooth flank 12b is a border portion 15b. An intersection line between the end surface 14 and the tooth flank 12c is a border portion 15c. An intersection line between the end surface 14 and each of the bottom land surfaces 13 is a border portion 15d.

The plurality of teeth 12 of such a gear 10 are formed by a gear cutter or a rolling device (not shown). Thereafter, a plurality of the border portions 15b to 15d are chamfered by the tool 20. Lastly, the border portions 15a are chamfered by another tool (not shown).

As shown in FIG. 2A and FIG. 2B, the tool 20 includes: a shank 21 having a columnar shape and having a center at a tool axis C2; a body 22 provided at a front end (on the lower side in FIG. 2A) in an axial direction of the shank 21; and a cutting part 23 protruding in a radial direction from the body 22. The body 22 has such a shape as to be further tapered at a position thereof farther from the shank 21 in the axial direction.

The shank 21 has a rear end side (the upper side in FIG. 2A) opposite to the body 22 in the axial direction. The rear end side is held by a working machine such as a composite processing machine. From the working machine, a drive force for rotating the tool 20 about the tool axis C2 is transmitted. Through the rotation of the tool 20, the border portions 15b to 15d of the gear 10 are chamfered by the cutting part 23. A rotation direction Rt of the tool 20 at the time of chamfering by the cutting part 23 is a clockwise direction as seen from the front end side in the axial direction shown in FIG. 2B.

The cutting part 23 is a portion protruding outward in the radial direction from an outer circumferential surface of the body 22, and, in the present embodiment, only one such cutting part 23 is formed around the tool axis C2. The cutting part 23 has: a machining edge 24 for chamfering the border portions 15b to 15d; a rake surface 25 extending from the machining edge 24 to the tool axis C2 side; and a flank surface 26 extending from the machining edge 24 backward in the rotation direction Rt.

The machining edge 24 is a cutting edge formed from a front end toward a rear end in the axial direction of the tool 20 by an intersection line between the rake surface 25 and the flank surface 26. The shape of the machining edge 24 is determined according to the shapes of the border portions 15b to 15d to be chamfered. Specifically, the shape of the machining edge 24 extends from the front end in the axial direction of the tool 20 perpendicularly to the tool axis C2 and then is curved so as to form a protrusion, a recess, and a protrusion in this order while extending to the rear end side.

The machining edge 24 is a portion smaller than a maximum radius of the tool 20 (shank 21). That is, the machining edge 24 is a portion located closer to the front end than an imaginary line L in FIG. 2A. A portion of the machining edge 24 near the imaginary line L and a linear portion contiguous with the machining edge 24 and extending to the rear end side beyond the imaginary line L do not chamfer the border portions 15b to 15d.

The rake surface 25 is a surface for removing chips generated upon chamfering by the machining edge 24 and faces forward in the rotation direction Rt in the cutting part 23. The rake surface 25 is located on an imaginary plane Pr including the tool axis C2 and is extended to the rear end side beyond the imaginary line L. The shank 21 has a helically-formed supply hole 22a having a lower end opened toward the rake surface 25. Through the supply hole 22a, a cutting fluid is supplied to the rake surface 25 during chamfering (cutting) by the tool 20, whereby the chamfer portion is cooled, lubricated, and cleaned.

The flank surface 26 is a surface for avoiding further contact between the tool 20 and the portion chamfered by the machining edge 24. The flank surface 26 is further retracted to the tool axis C2 side at a position thereof farther from the machining edge 24 in a circumferential direction.

In order to manufacture the tool 20, a columnar alloy to compose the shank 21 is ground to cut the body 22, the rake surface 25, and the flank surface 26. Each of the rake surface 25 and the flank surface 26 formed through this grinding preferably has a surface roughness Rz (roughness at maximum height) of 1.6 or less. In this case, it can be made less likely for a burr to be generated during chamfering by the tool 20.

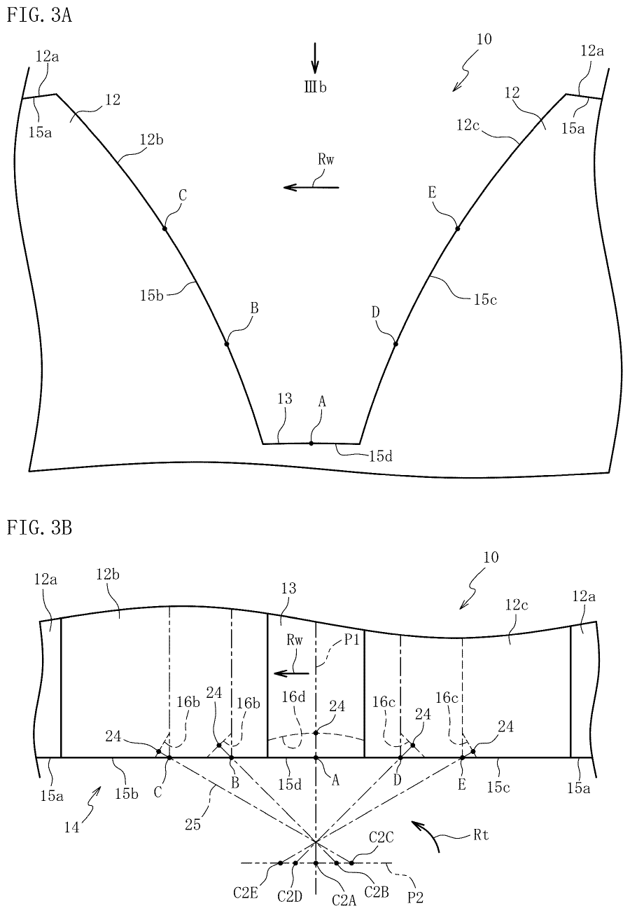

Next, a method for chamfering the gear 10 by the tool 20 will be described in detail with reference to FIG. 1, FIG. 3A, and FIG. 3B. Although a case where the border portions 15b to 15d on the right side in FIG. 1 are chamfered by the tool 20 will be described below, the same applies to a case where the border portions 15b to 15d on the left side in FIG. 1 are chamfered.

FIG. 3A is a partially enlarged front view of the gear 10 as seen in the direction (the axial direction of the rotation axis C1) indicated by the arrow IIIa in FIG. 1. FIG. 3B is a partially enlarged plan view of the gear 10 as seen in the direction (radial direction) indicated by the arrow IIIb in FIG. 3A.

In order to chamfer the border portions 15b to 15d of the gear 10 by the tool 20, a machining orientation of the tool 20 with respect to the gear 10 is determined first (preparation step). Then, the tool 20 in this machining orientation is rotated in the rotation direction Rt about the tool axis C2 while the gear 10 is being rotated in a rotation direction Rw about the rotation axis C1, whereby the machining edge 24 is sequentially brought into contact with the plurality of border portions 15b to 15d (chamfering step). The rotation direction Rw in the present embodiment is the anticlockwise direction from the tooth flank 12c toward the tooth flank 12b.

The machining orientation in the present embodiment corresponds to a state where arrangement is made such that: the rotation axis C1 and the tool axis C2 become orthogonal to each other; and the front end of the tool 20 comes into contact with any of the bottom land surfaces 13 as seen in the axial direction of the rotation axis C1. Since the rotation axis C1 and the tool axis C2 are orthogonal to each other, the tool axis C2 is located on a first imaginary plane P1 including the rotation axis C1 and is located on a second imaginary plane P2 perpendicular to the rotation axis C1. In FIG. 1, the axial direction of the rotation axis C1 is indicated as the arrow-Y direction, the axial direction of the tool axis C2 is indicated as an arrow-Z direction, and a direction perpendicular to the rotation axis C1 and the tool axis C2 is indicated as an arrow-X direction.

The chamfering step includes performing K·Zt/Zw rotations of the gear 10 per rotation of the tool 20. “K” represents an arbitrary integer and is set to 1 in the present embodiment. “Zt” represents the number of the machining edges 24 of the tool 20 and is 1 in the present embodiment. “Zw” represents the number of the teeth 12 of the gear 10 and is 18 in the present embodiment. That is, the chamfering step in the present embodiment includes performing 1/18 rotations of the gear 10 per rotation of the tool 20. The period of one rotation of the tool 20 is one cycle of the chamfering step.

FIG. 3A and FIG. 3B show contact positions A to E between the border portions 15b to 15d and the machining edge 24 during the one cycle. The contact position A is a position at which the machining edge 24 is brought into contact with the center in the circumferential direction of the border portion 15d. The contact position B is a position at which the machining edge 24 is brought into contact with the border portion 15b. The contact position C is a position that is higher (closer to the top land surface 12a) than the contact position B and at which the machining edge 24 is brought into contact with the border portion 15b. The contact position D is a position that is at the same height as the height of the contact position B and at which the machining edge 24 is brought into contact with the border portion 15c. The contact position E is a position that is at the same height as the height of the contact position C and at which the machining edge 24 is brought into contact with the border portion 15c.

Furthermore, in FIG. 3B, a position of the tool axis C2 corresponding to the contact position A is indicated as an axial position C2A. Likewise, in FIG. 3B, positions of the tool axis C2 corresponding to the respective contact positions B to E are indicated as axial positions C2B to C2E, respectively. Also, in FIG. 3B, positions of the rake surface 25 corresponding to the respective contact positions A to E are indicated by alternate long and short dash lines.

In addition, in FIG. 3B, the shape of a chamfer portion 16d formed by chamfering the border portion 15d by the machining edge 24 is indicated by a broken line. Also, in FIG. 3B, the shapes, near the contact positions B and C, of chamfer portions 16b formed by chamfering the border portion 15b by the machining edge 24 are indicated by broken lines. Likewise, the shapes, near the contact positions D and E, of chamfer portions 16c formed by chamfering the border portion 15c by the machining edge 24 are indicated by broken lines.

According to FIG. 3A and FIG. 3B, the border portions 15b to 15d are continuously chamfered during the one cycle of the chamfering step such that the machining edge 24 passes through the contact positions E, D, A, B, and C in this order. Regarding this one cycle, when the tool 20 is moved relative to the gear 10, the tool 20 is rotated in the rotation direction Rt while the position of the tool axis C2 is being shifted from the axial position C2E to the axial position C2C in a direction opposite to the rotation direction Rw as shown in FIG. 3B.

At the contact position A, the tool axis C2 (axial position C2A) and the machining edge 24 are arranged on the first imaginary plane P1 passing through the center in the circumferential direction of the border portion 15d. Therefore, the manner of motion in synchronous rotation of the tool 20 relative to the gear 10 is symmetric between both sides of the first imaginary plane P1. Therefore, the chamfer portions 16b to 16d can be formed to be symmetric about the contact position A between both sides in the circumferential direction of the gear 10.

The preparation step includes determining an initial phase of the machining edge 24 such that the tool axis C2 and the machining edge 24 are arranged on the first imaginary plane P1 passing through the center in the circumferential direction of the border portion 15d at the contact position A in the chamfering step. The initial phase of the machining edge 24 is a position of the machining edge 24 with respect to the tool axis C2 and the gear 10 at start of rotation of the tool 20 (machining edge 24). By such determination of the initial phase, the chamfer portions 16b to 16d can be formed to be symmetric about the contact position A as described above.

The initial phase may specifically correspond to: a state where the tool axis C2 and the machining edge 24 are arranged on the above first imaginary plane P1; or a state where the gear 10 and the tool 20 are synchronously rotated from the aforementioned state as in the chamfering step. For example, the initial phase may correspond to the positional relationship among the tool axis C2, the machining edge 24, and the gear 10 at any of the contact positions B to E. Alternatively, the initial phase may correspond to a state where the gear 10 is synchronously rotated while the tool 20 is rotated by 90 degrees or 180 degrees from the state where the contact position A is taken.

In a case where the machining edge 24 and the gear 10 interfere with each other in the initial phase, it is preferable that: the tool 20 is placed away from the gear 10 in the axial direction of the rotation axis C1 or the radial direction in advance; and the tool 20 is placed close to the gear 10 during the chamfering step. Consequently, the machining edge 24 gradually and deeply cuts the border portions 15b to 15d, whereby chipping or the like of the machining edge 24 and the border portions 15b to 15d can be suppressed.

In addition, as described with reference to FIG. 2B, the machining edge 24 and the rake surface 25 are located on the imaginary plane Pr including the tool axis C2, whereby the phase of the machining edge 24 to be rotated about the tool axis C2 can be easily identified from the orientation of the rake surface 25. Therefore, the preparation step includes determining the initial phase of the machining edge 24 on the basis of the rake surface 25, whereby the initial phase can be easily determined.

Furthermore, as described with reference to FIG. 2A, the rake surface 25 is extended to the rear end side beyond the imaginary line L (machining edge 24). Consequently, the rake surface 25 as a basis for determining the initial phase of the machining edge 24 can be widened. Therefore, the orientation or the like of the rake surface 25 can be easily acquired by a sensor or the like, whereby the initial phase can be more easily determined.

Description will be given with reference back to FIG. 3A and FIG. 3B. The chamfer portion 16d is formed by chamfering substantially the entirety of the border portion 15d by the protrusion of the machining edge 24 closest to the front end thereof. Therefore, the shape and the angle of the chamfer portion 16d can be set to be approximately even over the entirety thereof in the circumferential direction.

Here, in a case where the end surface 14 of the gear 10 and the chamfer portions 16b to 16d are parallel to each other, the angles of the chamfer portions 16b to 16d are regarded as 0 degrees. At each of the contact positions B to E, the tilt angle of the rake surface 25 (machining edge 24) with respect to the end surface 14 is approximately equal to the angle of the corresponding one of the chamfer portions 16b and 16c. Therefore, when the timing for forming the chamfer portions 16b or 16c by the machining edge 24 in the chamfering step differs between the contact position B or D and the contact position C or E, the tilt angle of the rake surface 25 varies and the angles of the chamfer portions 16b or 16c differ from each other, according to the difference in this timing. In the third and fourth embodiments described later, a method for making it less likely for the angles of the chamfer portions 16b or 16c to differ from each other will be described.

As described above, the chamfering step in the present embodiment includes repeating one cycle in which the border portions 15c, 15d, and 15b are continuously chamfered in this order by the machining edge 24 through synchronous rotation of the gear 10 and the tool 20. Through this chamfering step, the border portions 15b to 15d of the plurality of teeth 12 can be sequentially chamfered. Therefore, the border portions 15b to 15d of the gear 10 can be chamfered in a short time.

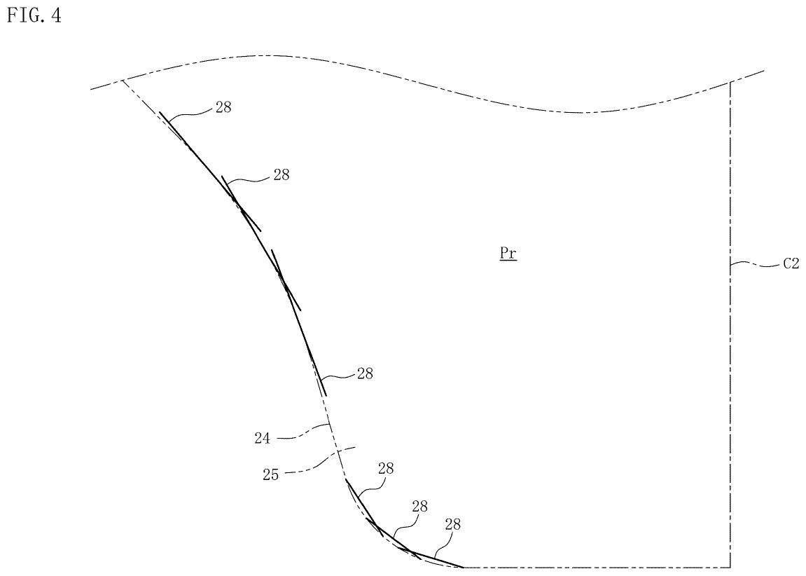

The machining edge 24 used in the chamfering step has a shape corresponding to the shapes of the border portions 15b to 15d as described above. A method for manufacturing the tool 20 including a method for designing this machining edge 24 will be described with reference to FIG. 1 and FIG. 4. FIG. 4 is a schematic diagram showing a part of the method for manufacturing the tool 20.

First, a shape of the gear 10 to be chamfered by the tool 20 is set (gear setting step). The shape of the gear 10 includes dimensions of the gear 10, the number Zw of the teeth 12, and shapes of the chamfer portions 16b to 16d to be formed by chamfering the border portions 15b to 15d.

Next, a shape of an imaginary rotation plane to be rotated about the tool axis C2 is set, the imaginary rotation plane being oriented in the rotation direction Rt of the tool 20 (rotation plane setting step). The imaginary rotation plane is a plane corresponding to the rake surface 25. In the present embodiment, the imaginary rotation plane set in the rotation plane setting step is the imaginary plane Pr including the tool axis C2.

Next, an initial phase of the imaginary plane Pr set in the rotation plane setting step, the machining orientation in the chamfering step in which the tool 20 being designed is to be used, the arbitrary integer K, and the number Zt of the machining edges 24 of the tool 20 are set (condition setting step). The machining orientation, the integer K, and the number Zt in the present embodiment are as explained above in the description of the chamfering step. The initial phase of the imaginary plane Pr is identical to the initial phase of the machining edge 24 (rake surface 25) in the above chamfering step.

Next, in the same manner as in the chamfering step, the K·Zt/Zw rotations of the gear 10 about the rotation axis C1 are performed during one rotation of the imaginary plane Pr about the tool axis C2 from the initial phase in the machining orientation based on the settings in the condition setting step and the gear setting step (acquisition step). The acquisition step includes acquiring intersection lines 28 between the imaginary plane Pr and the chamfer portions 16b to 16d in each of phases obtained when the synchronous rotation of the gear 10 and the imaginary plane Pr is performed.

In FIG. 4, some of a plurality of the intersection lines 28 acquired in the acquisition step are shown in a state of being arranged on the imaginary plane Pr. Also, in FIG. 4, the number, the sizes, the orientations, the positions, and the like of the intersection lines 28 are schematically indicated in order to facilitate understanding of the method for designing the shape of the machining edge 24.

A formation step subsequent to the acquisition step includes setting, as the machining edge 24, a line (envelope) in contact with the plurality of intersection lines 28 on a side opposite to the tool axis C2 and setting, as the rake surface 25, the imaginary plane Pr closer to the tool axis C2 than the machining edge 24 to form (design) the tool 20. Consequently, the machining edge 24 of the tool 20 formed in the formation step can actually chamfer the border portions 15b to 15d at positions close to the chamfer portions 16b to 16d set in the gear setting step. Therefore, the shapes of the chamfer portions 16b to 16d to be actually formed through chamfering can be made similar to the shapes of the chamfer portions 16b to 16d set in the gear setting step.

Also, after the formation step, whether the shape of the tool 20 needs to be set again may be determined through comparison between the shapes of the chamfer portions 16b to 16d actually formed by the tool 20 and the shapes of the chamfer portions 16b to 16d set in the gear setting step (determination step). The shapes of the chamfer portions 16b to 16d actually formed by the tool 20 may be calculated on a PC based on the shape of the machining edge 24 determined in the formation step.

The determination step includes determining that the shape of the tool 20 does not need to be set again, when the difference of the angles of the actual chamfer portions 16b to 16d from the angles of the set chamfer portions 16b to 16d is within a range of −10 degrees to +10 degrees, for example. Meanwhile, the determination step includes determining that the shape of the tool 20 needs to be set again, when the difference is outside this range. However, the method for determining necessity of setting the shape of the tool 20 again may be changed as appropriate according to the shape of the gear 10, a machining condition, and the like.

When determination that the shape of the tool 20 needs to be set again is performed in the determination step, at least one of the settings in the rotation plane setting step and the condition setting step is changed (changing step). After the changing step, the acquisition step and the formation step are performed again to form (design) the tool 20. Furthermore, the steps from the determination step to the formation step may be repeated as necessary to complete the tool 20. As a result of these steps, the shapes of the chamfer portions 16b to 16d to be actually formed by the tool 20 can be made more similar to the shapes of the chamfer portions 16b to 16d set in the gear setting step.

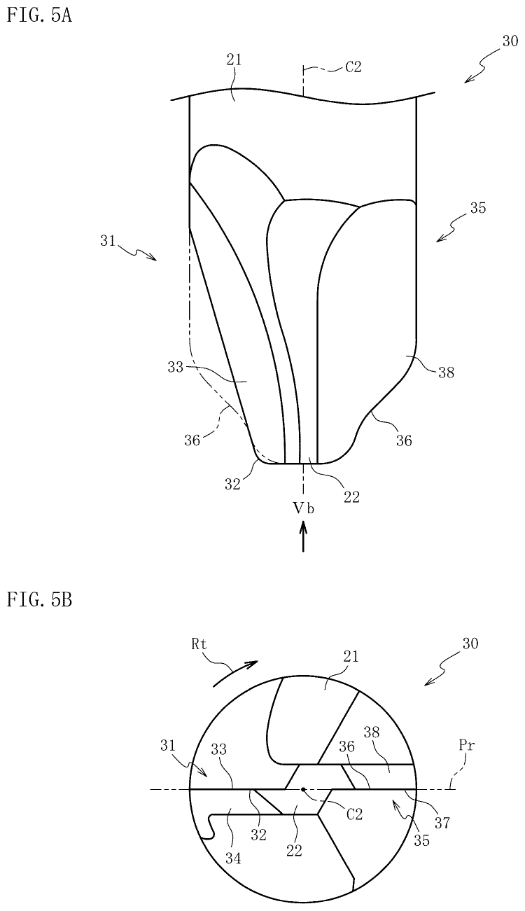

Next, a second embodiment will be described with reference to FIG. 5A and FIG. 5B. In the first embodiment, a tool 20 having one machining edge 24 has been described. Meanwhile, in the second embodiment, a chamfering tool 30 (hereinafter, referred to as “tool 30”) having two machining edges 32 and 36 will be described. The same components as those in the first embodiment are denoted by the same reference characters, and description thereof is omitted.

FIG. 5A is a front view of the chamfering tool 30 to be used for a method for chamfering the gear 10 in the second embodiment. FIG. 5B is a bottom view of the chamfering tool 30 as seen in the direction indicated by the arrow Vb in FIG. 5A. FIG. 5A does not show the rear end side (upper side) of the tool 30.

The tool 30 is for chamfering the same gear 10 as that in the first embodiment. The tool 30 includes: the shank 21; the body 22; and two cutting parts 31 and 35 formed around the tool axis C2 and protruding in the radial direction from the outer circumferential surface of the body 22.

The two cutting parts 31 and 35 are arranged away from each other by 180 degrees about the tool axis C2. The cutting part 31 has: a machining edge 32 for chamfering the border portions 15b to 15d of the gear 10; a rake surface 33 extending from the machining edge 32 to the tool axis C2 side; and a flank surface 34 extending from the machining edge 32 backward in the rotation direction Rt. Likewise, the cutting part 35 has a machining edge 36, a rake surface 37, and a flank surface 38. The rake surfaces 33 and 37 and flank surfaces 34 and 38 respectively have the same functions as those of the rake surface 25 and the flank surface 26 in first embodiment, and thus description thereof will be omitted.

The machining edge 32 is a cutting edge formed from the front end toward the rear end in the axial direction of the tool 30 by an intersection line between the rake surface 33 and the flank surface 34. The machining edge 36 is a cutting edge formed from the front end toward the rear end in the axial direction of the tool 30 by an intersection line between the rake surface 37 and the flank surface 38. Each of the machining edges 32 and 36 is located on the imaginary plane Pr including the tool axis C2.

In FIG. 5A which is a front view of the rake surface 33, the machining edge 36 having overlapped with the machining edge 32 as a result of rotating the machining edge 36 by 180 degrees about the tool axis C2 is indicated by an alternate long and two short dashes line. According to FIG. 5A, on the front end side of the tool 30, the machining edge 32 is located further outward in the radial direction than the machining edge 36. Meanwhile, on the rear end side of the tool 30, the machining edge 36 is located further outward in the radial direction than the machining edge 32.

Out of the machining edges 32 and 36, portions located relatively outward in the radial direction mainly chamfer the border portions 15b to 15d to form the chamfer portions 16b to 16d. The shapes of the portions located outward are designed through the same method as that for the machining edge 24 in the first embodiment. Meanwhile, out of the machining edges 32 and 36, portions located relatively inward in the radial direction have shapes designed in consideration of strength, ease of manufacturing, and the like.

A chamfering method in the second embodiment will be described mainly in relation to the differences from the chamfering method in the first embodiment. A chamfering step in which the tool 30 in the second embodiment is used includes chamfering continuous border portions 15b to 15d by the machining edge 32 during one half of a rotation of the tool 30 first in a case where the arbitrary integer K is set to 1. The chamfering step further includes subsequently chamfering continuous border portions 15b to 15d at positions adjacent to the chamfered border portions 15b to 15d in the circumferential direction, the subsequent chamfering being performed by the machining edge 36 during the other half of the rotation of the tool 30.

On one hand, in a case where the number Zw of the teeth 12 of the gear 10 is an odd number, border portions 15b to 15d chamfered by the machining edge 32 through a first rotation of the gear 10 are chamfered by the machining edge 36 through a second rotation of the gear 10. At this time, the portion of the machining edge 36 located further outward in the radial direction than the machining edge 32 is brought into contact with the border portions 15b to 15d to chamfer the border portions 15b to 15d, and the other border portions are not chamfered.

Likewise, border portions 15b to 15d chamfered by the machining edge 36 through the first rotation of the gear 10 are chamfered by the machining edge 32 through the second rotation of the gear 10. At this time, the portion of the machining edge 32 located further outward in the radial direction than the machining edge 36 is brought into contact with the border portions 15b to 15d to chamfer the border portions 15b to 15d, and the other border portions are not chamfered.

On the other hand, in a case where the number Zw of the teeth 12 of the gear 10 is an even number, each of the machining edges 32 and 36 continuously chamfers the same border portions 15b to 15d. In view of this, synchronous rotation of the gear 10 and the tool 30 is stopped upon one or more rotations of the gear 10 during the chamfering step. Thereafter, 1/Zw of a rotation of the gear 10 or ½ of a rotation of the tool 30 is performed to change the phase. Then, synchronous rotation of the gear 10 and the tool 30 is restarted. After this restart, the border portions 15b to 15d are chamfered by the machining edge 32 or 36 different from the machining edge used before the restart, as in the second rotation performed in the case where the number Zw of the teeth 12 is an odd number.

In the case where the number Zw of the teeth 12 is an even number, the machining orientation or the like can be set to differ between before and after the synchronous rotation is restarted during the chamfering step. Consequently, the sizes and the angles of the chamfers to be provided to the border portions 15b to 15d can be set to differ between the first rotation and the second rotation.

Also, in either case, the top land surface 12a sides of the border portions 15b to 15d of one of the teeth 12 can be chamfered by the machining edge 36, and the bottom land surface 13 sides of these border portions 15b to 15d can be chamfered by the machining edge 32. Thus, the shapes of the machining edges 32 and 36 at the portions thereof for chamfering the border portions 15b to 15d may be set independently of each other. By doing so, the sizes and the angles of the chamfers to be provided to the border portions 15b to 15d can be adjusted (e. g., set to be even) between the top land surface 12a sides and the bottom land surface 13 sides.

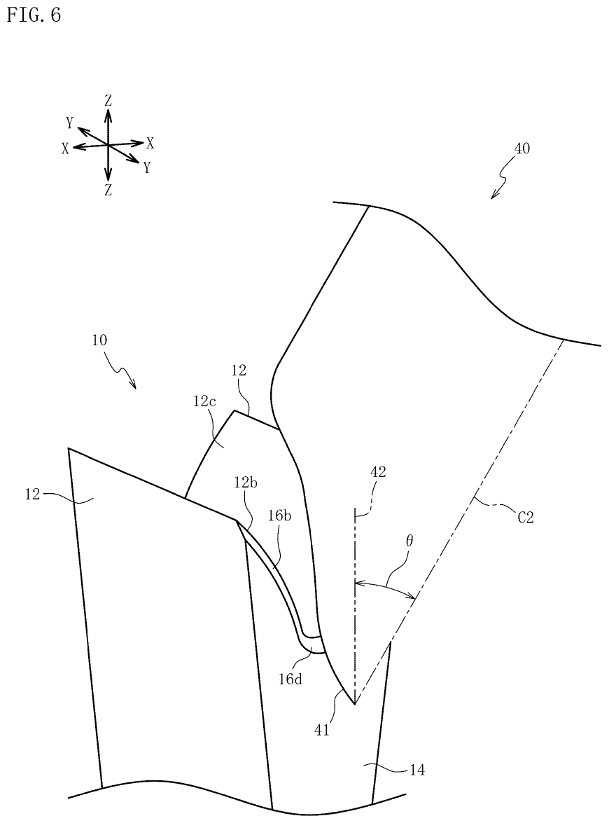

Next, a third embodiment will be described with reference to FIG. 6. In the first embodiment, a case has been described where the gear 10 is chamfered by the tool 20 in the machining orientation in which the rotation axis C1 and the tool axis C2 are orthogonal to each other. In the third embodiment, a case will be described where the gear 10 is chamfered by a chamfering tool 40 (hereinafter, referred to as “tool 40”) in a machining orientation in which the tool axis C2 is tilted in the arrow-Y direction from the machining orientation in the first embodiment. The same components as those in the first embodiment are denoted by the same reference characters, and description thereof is omitted.

FIG. 6 is a schematic diagram showing a method for chamfering the gear 10 in the third embodiment. FIG. 6 shows a pair of tooth flanks 12b and 12c that are parts of the gear 10 in the circumferential direction and that are opposed to each other in the circumferential direction. The gear 10 shown in FIG. 6 is in a state where the border portions 15b to 15d are chamfered so that the chamfer portions 16b to 16d are formed. FIG. 6 schematically shows only the tool axis C2 and a machining edge 41 out of the tool 40 for chamfering the gear 10.

The machining edge 41 of the tool 40 is a cutting edge formed around the tool axis C2 from the front end toward the rear end in the axial direction of the tool 40. The tool 40 including the machining edge 41 is formed substantially in the same manner as the tool 20 in the first embodiment, except that the shape of a part of the tool 40 differs. The shape of the machining edge 41 is designed by changing the machining orientation in the acquisition step as in the following third embodiment in the same manner as in the design method described in the first embodiment.

A chamfering method in the third embodiment will be described mainly in relation to the differences from the chamfering method in the first embodiment. In a machining orientation in the third embodiment, the tool axis C2 is located on the first imaginary plane P1 (see FIG. 3B) which is a Y-Z plane including the rotation axis C1 (see FIG. 1). Furthermore, this machining orientation corresponds to a state where the tool axis C2 is tilted by a tilt angle θ in the arrow-Y direction from the second imaginary plane P2 (see FIG. 3B) which is an X-Z plane. In FIG. 6, an imaginary line 42 extending parallel to the second imaginary plane P2 from the front end on the tool axis C2 is indicated by an alternate long and two short dashes line. The angle between the imaginary line 42 and the tool axis C2 is the tilt angle θ.

When the chamfering step is performed in this machining orientation, the machining edge 41 is tilted in the circumferential direction of the gear 10 in association with rotation of the tool 40 as seen in the arrow-Y direction (the axial direction of the rotation axis C1). Consequently, the machining edge 41 and the border portions 15b and 15c (portions at which the chamfer portions 16b and 16c have yet to be formed) of each of the teeth 12 may become nearly parallel to each other. When the machining edge 41 and the border portions 15b and 15c become nearly parallel to each other through adjustment of the tilt angle θ or the like, the machining edge 41 is brought into contact with the border portions 15b and 15c to chamfer the border portions 15b and 15c. Consequently, the entireties of the border portions 15b and 15c can be chamfered by the machining edge 41 in a short time. As a result, the top land side and the bottom land side of each of the border portions 15b and 15c are equally chamfered by the machining edge 41.

Specifically, the tilt angle of the machining edge 41 with respect to the end surface 14 at which the machining edge 41 is brought into contact with the border portions 15b and 15c such as the angle described with reference to FIG. 3B can be set to be even between the top land side and the bottom land side. Therefore, the sizes and the angles of the chamfers to be provided to the border portions 15b and 15c by the machining edge 41 can be set to be even over the entireties of the border portions 15b and 15c.

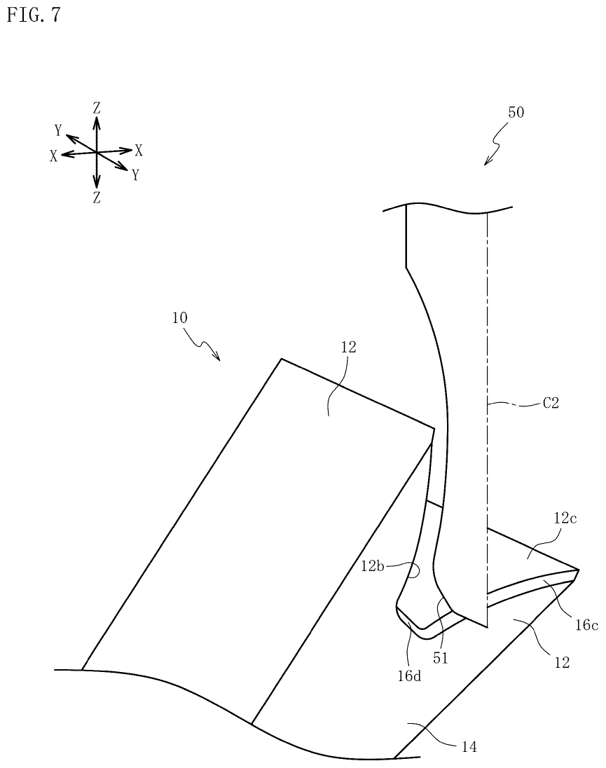

Next, a fourth embodiment will be described with reference to FIG. 7. In the first embodiment, a case has been described where the gear 10 is chamfered by the tool 20 in the machining orientation in which the rotation axis C1 and the tool axis C2 are orthogonal to each other. In the fourth embodiment, a case will be described where the gear 10 is chamfered by a chamfering tool 50 (hereinafter, referred to as “tool 50”) in a machining orientation in which the tool axis C2 is parallelly shifted in the arrow-X direction from the machining orientation in the first embodiment. The same components as those in the first embodiment are denoted by the same reference characters, and description thereof is omitted.

FIG. 7 is a schematic diagram showing a method for chamfering the gear 10 in the fourth embodiment. Similar to FIG. 6, FIG. 7 shows a part of the gear 10 in the circumferential direction. The gear 10 shown in FIG. 7 is in a state where the border portions 15b to 15d are chamfered so that the chamfer portions 16b to 16d are formed. FIG. 7 schematically shows only the tool axis C2 and a machining edge 51 out of the tool 50 for chamfering the gear 10.

The machining edge 51 of the tool 50 is a cutting edge formed around the tool axis C2 from the front end toward the rear end in the axial direction of the tool 50. The tool 50 including the machining edge 51 is formed substantially in the same manner as the tool 20 in the first embodiment, except that the shape of a part of the tool 50 differs. The shape of the machining edge 51 is designed by changing the machining orientation in the acquisition step as in the following fourth embodiment in the same manner as in the design method described in the first embodiment.

A chamfering method in the fourth embodiment will be described mainly in relation to the differences from the chamfering method in the first embodiment. A machining orientation in the fourth embodiment corresponds to a state where: the tool axis C2 is parallel to the arrow-Z direction; and the tool axis C2 is parallelly shifted in the arrow-X direction perpendicular to the first imaginary plane P1 from a position on the first imaginary plane P1 (see FIG. 3B).

In this machining orientation, one or more of the border portions 15b and 15c (portions at which the chamfer portions 16b and 16c have yet to be formed) of the plurality of teeth 12 become nearly parallel to the tool axis C2. In FIG. 7, in a case where the tool 50 is oriented downward, the tool axis C2 and the border portion 15b (a border of the tooth flank 12b) of a tooth 12 on the upper right of the gear 10 become nearly parallel to each other.

The chamfering step includes bringing the machining edge 51 into contact with the border portion 15b having become nearly parallel to the tool axis C2 to chamfer the border portion 15b. Consequently, the entirety of this border portion 15b can be chamfered by the machining edge 51 in a short time. As a result, the top land side and the bottom land side of the border portion 15b are equally chamfered by the machining edge 51.

Specifically, the tilt angle of the machining edge 51 with respect to the end surface 14 at which the machining edge 51 is brought into contact with the border portion 15b such as the angle described with reference to FIG. 3B can be set to be even between the top land side and the bottom land side. Therefore, the size and the angle of the chamfer to be provided to the border portion 15b by the machining edge 51 can be set to be even over the entirety of the border portion 15b.

After the border portion 15b is chamfered, the chamfering step is performed with the machining orientation being partially changed in order to also chamfer the border portion 15c. In a case where the tool 50 is oriented downward, the tool axis C2 and the border portion 15b of a tooth 12 on the upper right of the gear 10 become nearly parallel to each other as described above with reference to FIG. 7. In this case, the border portion 15c (a border of the tooth flank 12c) of a tooth 12 on the upper left of the gear 10 also becomes nearly parallel to the tool axis C2.

Therefore, the chamfering step for the border portion 15c includes adjusting the machining orientation (the position in the arrow-X direction) such that the machining edge 51 comes into contact with the border portion 15c having become nearly parallel to the tool axis C2 to chamfer the border portion 15c. As a result, the size and the angle of the chamfer to be provided to the border portion 15c by the machining edge 51 can be set to be even over the entirety of the border portion 15c in the same manner as in chamfering of the border portion 15b.

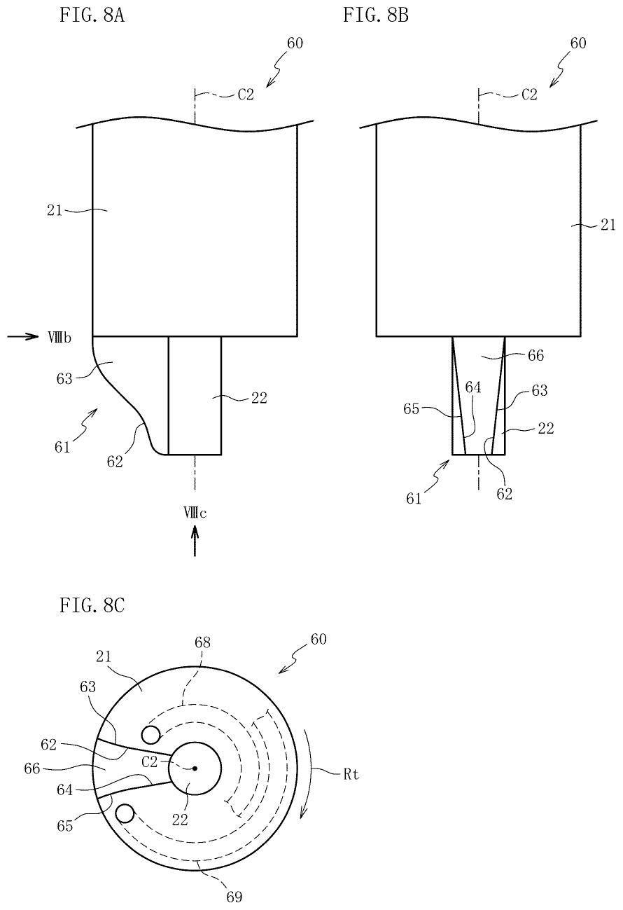

Next, a fifth embodiment will be described with reference to FIG. 8A to FIG. 8C. In the first embodiment, a tool 20 including a cutting part 23 having one machining edge 24 has been described. In the fifth embodiment, a chamfering tool 60 (hereinafter, referred to as “tool 60”) including a cutting part 61 having two machining edges 62 and 64 will be described. The same components as those in the first embodiment are denoted by the same reference characters, and description thereof is omitted.

FIG. 8A is a front view of the tool 60 to be used for a method for chamfering the gear 10 in the fifth embodiment. FIG. 8B is a side view of the tool 60 as seen in the direction indicated by the arrow VIIIb in FIG. 8A. FIG. 8C is a bottom view of the tool 60 as seen in the direction indicated by the arrow VIIIc in FIG. 8A. FIG. 8A and FIG. 8B do not show the rear end side (upper side) of the tool 60.

The tool 60 is for chamfering the same gear 10 as that in the first embodiment. The tool 60 includes: the shank 21 having a columnar shape and having a center at the tool axis C2; the body 22 having a columnar shape and provided at the front end in the axial direction of the shank 21; and one cutting part 61 protruding in the radial direction from the outer circumferential surface of the body 22.

The cutting part 61 has: a forward rake surface 63 facing forward in the rotation direction Rt; a backward rake surface 65 facing backward in the rotation direction Rt; and a connection surface 66 connecting radially outer borders of the forward rake surface 63 and the backward rake surface 65 to each other. An intersection line between the forward rake surface 63 and the connection surface 66 forms the machining edge 62. An intersection line between the backward rake surface 65 and the connection surface 66 forms the machining edge 64. The machining edges 62 and 64 are cutting edges formed from the front end toward the rear end in the axial direction of the tool 60.

The forward rake surface 63 is a surface for removing chips generated upon chamfering by the machining edge 62. The shank 21 has a helically-formed supply hole 68 having a lower end opened toward the forward rake surface 63. Through the supply hole 68, a cutting fluid is supplied to the forward rake surface 63 during chamfering by the tool 60, whereby the chamfer portion is cooled, lubricated, and cleaned.

The backward rake surface 65 is a surface for removing chips generated upon chamfering by the machining edge 64. The shank 21 has a helically-formed supply hole 69 having a lower end opened toward the backward rake surface 65. Through the supply hole 69, a cutting fluid is supplied to the backward rake surface 65 during chamfering by the tool 60, whereby the chamfer portion is cooled, lubricated, and cleaned.

Since the forward rake surface 63 and the backward rake surface 65 are oriented in mutually-opposite directions, the helixes of the supply hole 68 and the supply hole 69 for supplying cutting fluids to the forward rake surface 63 and the backward rake surface 65 are also oriented in mutually-opposite directions. However, the supply hole 68 and the supply hole 69 are formed at positions shifted from each other in the radial direction. Consequently, the supply holes 68 and 69 having different orientations can be formed in the shank 21 without interference between the supply holes 68 and 69.

As described above, the cutting part 61 of the tool 60 has the pair of machining edges 62 and 64. Therefore, adjustment of the machining orientation during the chamfering step makes it possible to, during one rotation of the tool 60, chamfer any of the border portions 15b by the machining edge 62 and chamfer the border portion 15c adjacent to the border portion 15b in the circumferential direction by the machining edge 64. In this case, as compared to, for example, the first embodiment in which both of the adjacent border portions 15b and 15c are chamfered by the same machining edge 24, the machining edges 62 and 64 can be formed into shapes suitable for the respective border portions 15b and 15c, whereby the size and the angle of the chamfer to be provided to each of the border portions 15b and 15c can be easily adjusted.

Specifically, each of the machining edge 62 and the forward rake surface 63 is tilted further forward in the rotation direction at a position thereof closer to the rear end. The amount of the tilt is set such that, when the machining edge 62 is brought into contact with the border portion 15b, the range of the contact therebetween becomes wide from the top land side to the bottom land side. Consequently, the entirety of the border portion 15b can be chamfered by the machining edge 62 in a short time, and the top land side and the bottom land side of the border portion 15b are equally chamfered by the machining edge 62. Therefore, the size and the angle of the chamfer to be provided to the border portion 15b can be set to be even over the entirety of the border portion 15b.

Likewise, each of the machining edge 64 and the backward rake surface 65 is tilted further backward in the rotation direction at a position thereof closer to the rear end. The amount of the tilt is set such that, when the machining edge 64 is brought into contact with the border portion 15c, the range of the contact therebetween becomes wide from the top land side to the bottom land side. Consequently, the entirety of the border portion 15c can be chamfered by the machining edge 64 in a short time, and the top land side and the bottom land side of the border portion 15c are equally chamfered by the machining edge 64. Therefore, the size and the angle of the chamfer to be provided to the border portion 15c can be set to be even over the entirety of the border portion 15c.

Although the present invention has been described above based on the embodiments, the present invention is not limited to the above embodiments at all. It can be easily understood that various modifications may be made without departing from the gist of the present invention.

The numerical values used in the above embodiments are merely examples and, as a matter of course, may be replaced with other numerical values. For example, the number Zt of the machining edges 24, 32, 36, 41, 51, 62, 64 (hereinafter, referred to as “machining edge 24, etc.”) provided to the tools 20 to 60 may be one or may be two or more. The surface roughness Rz of the rake surface 25, 33, or 37, the flank surface 26, 34, or 38, or the like may be made higher than 1.6.

Although a case where the gear 10 is an external gear has been described in the above embodiments, the present invention is not limited thereto. The gear 10 may be an internal gear including: an annular member; and a plurality of teeth 12 protruding inward in the radial direction from an inner circumferential surface of the annular member. Also, without limitation to a case where a flank line direction in which the teeth 12 extend is parallel to the rotation axis C1, the flank line direction may be tilted from the rotation axis C1.

Although a case where the supply hole 22a, 68, 69 of the tool 20, 60 is helically formed has been described in the above embodiments, the present invention is not limited thereto. For example, the supply hole 22a, 68, 69 may be linearly formed. Also, the helical or linear supply hole 22a, 68, 69 may be provided to the tool 30, 40, 50.

Although a case where the machining edge 24, 32, 36, 41, 51 is located on the imaginary plane Pr including the tool axis C2 has been described in the above embodiments, it is allowable for the machining edge 24, 32, 36, 41, 51 to not be located on the imaginary plane Pr, similar to the machining edges 62 and 64. In this case, a plane as a basis for determining the initial phase of the machining edge 24, etc. is preferably provided to the outer circumferential surface of the shank 21 or the body 22. This plane as a basis is preferably parallel to the imaginary plane Pr in order to facilitate identification of the phase of the machining edge 24, etc. to be rotated about the tool axis C2.

Although a case where the border portion 15b and the border portion 15c are chamfered by the machining edge 24, 32, 36, 41, 51 of the same tool 20 to 50 in the chamfering step has been described in the above embodiments, the present invention is not limited thereto. It is allowable to change the machining orientation, the machining condition, the shape of the tool 20 to 50, or the like as appropriate and chamfer only the border portion 15b by the tool 20 to 50. In this case, it is allowable to chamfer only the border portion 15c by using a tool different from the tool 20 to 50 for chamfering the border portion 15b.

Although a case where one tool 30 is provided with the machining edge 32 for chamfering the bottom land sides of the border portions 15b to 15d and the machining edge 36 for chamfering the top land sides of the border portions 15b to 15d has been described in the above second embodiment, the present invention is not limited thereto. A tool for chamfering the bottom land sides of the border portions 15b to 15d and a tool for chamfering the top land sides of the border portions 15b to 15d may be separately prepared. For example, it is allowable to, after the border portions 15b to 15d are entirely chamfered by the tool 20, further chamfer only the top land sides of the border portions 15b to 15d by another tool.

Although a case where the rotation direction Rw of the gear 10 and the rotation direction Rt of the tool 20 to 60 are almost identical to each other near a portion to be chamfered in the chamfering step has been described in the above embodiments, the present invention is not limited thereto. It is allowable to set only the rotation direction Rw to an opposite direction to the identical copying direction. In the case of the opposite direction, the machining edge 24, etc. swiftly chamfers the border portions 15b to 15d of the gear 10 to form chamfer portions 16b to 16d, whereby the angles of the chamfer portions 16b to 16d easily become small. In this case, when the outer diameter of the tool 20 to 60 is made small, the angles of the chamfer portions 16b to 16d can be adjusted by increasing the angles. In other words, in the case of the opposite direction, the outer diameter of the tool 20 to 60 is easily made smaller than in the case of the copying direction.

Although examples of the machining orientation in the chamfering step have been presented in the above embodiments, the machining orientation is not limited to the presented examples. The machining orientation only has to be an orientation in which the rotation axis C1 and the tool axis C2 are at least set non-parallel. For example, the machining orientation may correspond to a state where: the tool axis C2 is tilted from the second imaginary plane P2 in the arrow-Y direction as in the third embodiment; and the tool axis C2 is parallelly shifted in a direction perpendicular to the first imaginary plane P1 from a position on the first imaginary plane P1 as in the fourth embodiment.

Although a case where the border portions 15b to 15d of the gear 10 are chamfered by the tool 20 to 60 in the chamfering step has been described in the above embodiments, the present invention is not limited thereto. The machining orientation, the shape of the tool 20 to 60, or the like may be changed such that the tool 20 to 60 chamfers the border portions 15b and 15c of the gear 10 and does not chamfer the border portion 15d of the gear 10. In contrast, the machining orientation, the shape of the tool 20 to 60, or the like may be changed such that the border portion 15d is chamfered and the border portions 15b and 15c are not chamfered. Also, the machining orientation, the shape of the tool 20 to 60, or the like may be changed such that the tool 20 to 60 also chamfers the border portion 15a of the gear 10.

In the chamfering step in which the tool 20, 30, 40, 60 is used, the machining orientation or the like may be changed such that only one of the border portions 15b and 15c is chamfered and the other one is not chamfered. In this case, as in the above fourth embodiment, it is allowable to partially change the machining orientation and then chamfer only the other one of the border portions 15b and 15c that has not been chamfered before the change.

Although a case where the arbitrary integer K in the chamfering step is 1 has been presented as an example in the above embodiments, the integer K may be set to 2 or more. However, in a case where the integer K is 1, the plurality of teeth 12 arranged in the circumferential direction can be chamfered by the machining edge 24, etc. without any skipping in the chamfering step. Meanwhile, in a case where the integer K is 2 or more, the plurality of teeth 12 arranged in the circumferential direction are chamfered by the machining edge 24, etc. with one or more of the teeth 12 being skipped in the chamfering step.

For example, in a case where the integer K is 2, the plurality of teeth 12 are chamfered with one of the teeth 12 being skipped. In this case, when the number Zw of the teeth 12 is an odd number, the tooth 12 skipped in the first rotation of the gear 10 is chamfered in the second rotation. That is, in the case where the integer K is 2 and the number Zw of the teeth 12 is an odd number, the plurality of teeth 12 can be equally chamfered without temporarily stopping synchronous rotation of the gear 10 and the tool 20 to 60 in the same manner as in the case where the integer K is 1. The same applies to a case where the integer K and the number Zw of the teeth 12 are coprime.

In a case where the integer K and the number Zw of the teeth 12 are not coprime such as a case where the integer K is 2 and the number Zw of the teeth 12 is an even number, it is necessary to, after temporarily stopping the synchronous rotation, rotate only one of the gear 10 or the tool 20 to 60 and restart the synchronous rotation as in the chamfering step in the above second embodiment. In this case, the machining orientation or the like can be set to differ between before and after the synchronous rotation is restarted. Consequently, the sizes and the angles of the chamfers to be provided to the teeth 12 can be set to differ between before and after the synchronous rotation is restarted.

### DESCRIPTION OF REFERENCE NUMERALS

10 gear
12 teeth
12b, 12c tooth flank
15b, 15c border portion
16b, 16c chamfer portion
20, 30, 40, 50, 60 chamfering tool
24, 32, 36, 41, 51, 62, 64 machining edge
25, 33, 37 rake surface
61 cutting part
63 forward rake surface
65 backward rake surface
66 connection surface
C1 rotation axis
C2 tool axis
P1 first imaginary plane
P2 second imaginary plane
Pr imaginary plane (third imaginary plane, rotation plane)

1-8. (canceled)

9. A gear chamfering method comprising a chamfering step of chamfering, by a chamfering tool configured to be rotated about a tool axis, a gear having a plurality of teeth formed around a rotation axis, wherein
each of the plurality of teeth has
a tooth flank as a surface oriented in a circumferential direction of the gear and
a border portion, in an axial direction of the rotation axis, of the tooth flank,
the chamfering tool has at least one machining edge formed around the tool axis into a shape corresponding to a shape of the border portion,
an arbitrary integer is represented by K, the number of the teeth is represented by Zw, and the number of the machining edges is represented by Zt, and
the chamfering step includes performing K·Zt/Zw rotations of the gear about the rotation axis per rotation of the chamfering tool about the tool axis in a machining orientation in which the tool axis is set non-parallel to the rotation axis, and sequentially bringing the machining edge into contact with a plurality of the border portions to chamfer the border portions.

10. The gear chamfering method according to claim 9, wherein the machining orientation is an orientation in which the tool axis is located on a first imaginary plane including the rotation axis.

11. The gear chamfering method according to claim 9, wherein
the number Zt of the machining edges is two or more, and
the chamfering step includes bringing different ones of the machining edges into contact with respective top land and bottom land sides of one of the border portions to chamfer the top land and bottom land sides.

12. The gear chamfering method according to claim 9, wherein
the machining orientation corresponds to a state where the tool axis located on a first imaginary plane including the rotation axis is parallelly shifted from the first imaginary plane in a direction perpendicular to the first imaginary plane,
the machining edge is formed from a front end toward a rear end in an axial direction of the chamfering tool, and
a border portion, in the axial direction of the rotation axis, of a bottom land surface as each of surfaces between the plurality of teeth is chamfered by the front end side of the machining edge.

13. The gear chamfering method according to claim 9, wherein the machining orientation corresponds to a state where the tool axis is tilted from a second imaginary plane perpendicular to the rotation axis.

14. The gear chamfering method according to claim 9, wherein
the chamfering tool has a rake surface extending from the machining edge to the tool axis side and facing forward in a rotation direction of the chamfering tool,
the rake surface and the machining edge are located on a third imaginary plane including the tool axis, and
an initial phase of the machining edge at start of rotation of the machining edge about the tool axis in the chamfering step is determined on the basis of the rake surface.

15. The chamfering tool to be used for the gear chamfering method according to claim 14, wherein
the machining edge is a portion having a radius smaller than a maximum radius of the chamfering tool and is formed on a front end side in an axial direction of the chamfering tool, and
the rake surface is extended to a side opposite to the front end side beyond a position at which the machining edge is formed.

16. The chamfering tool to be used for the gear chamfering method according to claim 9, wherein
the chamfering tool comprises a cutting part formed around the tool axis,
the cutting part has
a forward rake surface facing forward in a rotation direction of the chamfering tool,
a backward rake surface facing backward in the rotation direction of the chamfering tool, and
a connection surface connecting radially outer borders of the forward rake surface and the backward rake surface to each other, and
an intersection line between the connection surface and the forward rake surface and an intersection line between the connection surface and the backward rake surface form a pair of the machining edges configured to chamfer respective ones of the border portions.

17. A chamfering tool manufacturing method for manufacturing the chamfering tool to be used for the gear chamfering method according to claim 9,
the chamfering tool having
the machining edge and
a rake surface extending from the machining edge to the tool axis side and facing forward in a rotation direction of the chamfering tool, wherein
the chamfering tool manufacturing method comprises:
a gear setting step of setting a shape of the gear including the number Zw of the teeth and a shape of a chamfer portion to be formed by chamfering each of the border portions;
a rotation plane setting step of setting a shape of an imaginary rotation plane to be rotated about the tool axis, the imaginary rotation plane being oriented in the rotation direction of the chamfering tool;
a condition setting step of setting an initial phase of the rotation plane set in the rotation plane setting step, the machining orientation, the arbitrary integer K, and the number Zt of the machining edges;
an acquisition step of acquiring an intersection line between the rotation plane and the chamfer portion in each of phases obtained when the K·Zt/Zw rotations of the gear about the rotation axis are performed during one rotation of the rotation plane about the tool axis from the initial phase in the machining orientation based on the settings in the condition setting step and the gear setting step; and
a formation step of setting, as the machining edge, a line in contact with a plurality of the intersection lines acquired in the acquisition step and setting, as the rake surface, the rotation plane closer to the tool axis than the machining edge to form the chamfering tool.
